(19) United States
(12) Patent Application Publication
(10) Pub. No.: US 2004/0122763 A1
(43) Pub. Date: Jun. 24, 2004

(54) Method for managing credit limits of accounts receivable

(76) Inventor: Juei-Mei Wang, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/665,646

(22) Filed: Sep. 18, 2003

(30) Foreign Application Priority Data
Dec. 20, 2002 (TW) 91136969

(51) Int. Cl. G06F 17/60

(52) U.S. Cl. 705/39

(57) ABSTRACT

A method for managing credit limits of accounts receivable according to customers' credit ratings and transaction records. The method comprises the steps of: receiving purchase order data of a customer; calculating an account receivable of the purchase order according to the received data; retrieving credit limit data of the customer from a database server; comparing the account receivable of the purchase order with the credit limit; notifying relevant officer to refuse the purchase order when the account receivable of the purchase order exceeds the credit limit; and notifying relevant officer to accept the purchase order when the account receivable of the purchase order does not exceed the credit limit and subtracting the sum of the account receivable of the purchase order from the credit limit in the database server.

### BACKGROUND OF THE INVENTION

1. Field of the Invention

This invention relates to methods for managing accounts receivable of an enterprise, and more particularly to methods for managing credit limits of accounts receivable according to customers' credit ratings.

2. Description of Related Art

The effective management of accounts receivable is always an important subject of financial management of an enterprise. Nowadays, there are many computer systems developed for managing accounts receivable, mainly focusing on automatic booking and recording of accounting entries. Such computer systems make some improvements on reducing workload and human error. However, the efficient recovery and control of accounts receivable are still problematic.

A common problem is how to effectively control the credit limit of accounts receivable according to a customer's credit rating. Nowadays many sales transactions are conducted entirely on account, especially where a buyer and a seller are in an active, ongoing business relationship. If accounts receivable are not controlled properly, an enterprise may suffer great loss if the financial health of its customers fails.

US Pat. Publication No. 2002/0077972, published on Jun. 20, 2002, discloses a method and means for an on-line accounts receivable management system. The system of the invention can timely track current accounts receivable (AR) via a central server connecting with computer systems of banks and an AR agent whose business is to help enterprises recover their accounts receivable. Said system is directed to solving the problem of how to track and recover accounts receivable when excesses of accounts receivable occur. However, said system does not adequately address the issue of maintaining accounts receivable within reasonable credit limits beforehand.

Accordingly, what is needed is a method which can overcome the abovementioned problems.

### SUMMARY OF THE INVENTION

A primary object of the present invention is to provide a method which automatically refuses or accepts a customer's purchase order according to the customer's credit rating and credit limit.

Another object of the present invention is to provide a method which automatically sets a customer's credit limit according to the customer's credit rating, and which updates the customer's credit limit according to new transaction or payment information.

In one aspect of the present invention, a method for managing credit limits of accounts receivable is provided. The method comprises the steps of: setting a plurality of credit ratings, each of the credit ratings corresponding to a particular credit limit; selecting a credit rating for each of customers, corresponding credit rating data being stored in a database server; receiving purchase order data of a particular customer; calculating an account receivable of the purchase order according to the received purchase order data; retrieving credit limit data of the customer from the database server; comparing the account receivable of the purchase order with a credit limit of the customer; notifying a relevant officer to refuse the purchase order when the account receivable of the purchase order exceeds the credit limit; notifying a relevant officer to accept the purchase order when the account receivable of the purchase order does not exceed the credit limit, and subtracting the sum of the account receivable of the purchase order from the credit limit in the database server; receiving payment data of the customer; and adding a sum of a payment of the customer to the credit limit in the database server.

Other objects, advantages and novel features of the present invention will be drawn from the following detailed description of the present invention with attached drawings, in which:

### BRIEF DESCRIPTION OF THE DRAWINGS

FIG. 1 is a schematic diagram of hardware infrastructure of a system which can be used to implement the method of the present invention for managing credit limits of accounts receivable;

FIG. 2 is a block diagram showing data stored in a database server of the system of FIG. 1;

FIG. 3 is a schematic diagram of main function modules of an application server of the system of FIG. 1;

FIG. 4 is a flowchart for managing customers' credit limits, in accordance with the present invention;

FIG. 5 is a flowchart for adjusting a customer's credit limit after a payment by the customer, in accordance with the present invention; and

FIG. 6 is a flowchart for calculating bad account provisions, in accordance with the present invention.

### DETAILED DESCRIPTION OF THE PREFERRED EMBODIMENTS OF THE INVENTION

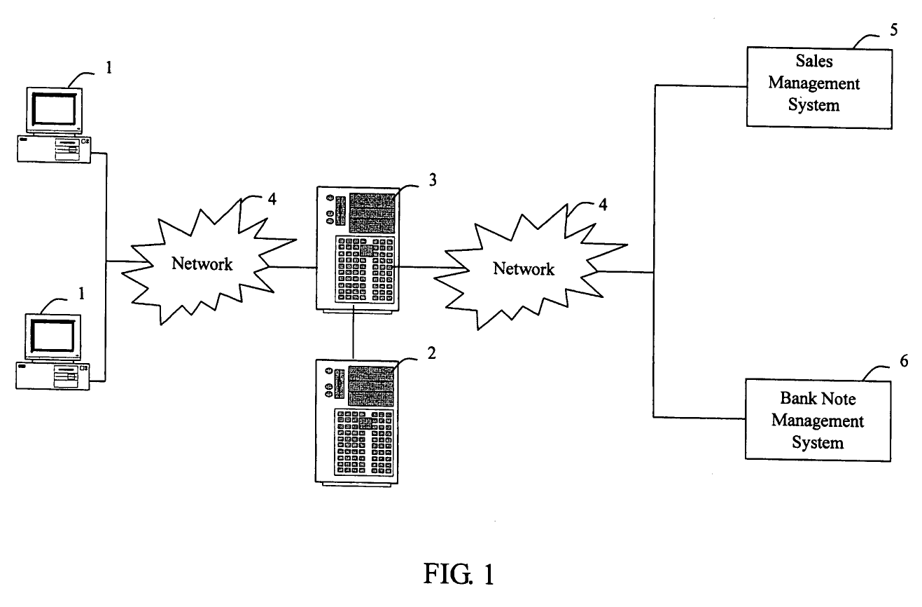

FIG. 1 is a schematic diagram of hardware infrastructure of a system which can be used to implement the method of the present invention for managing credit limits of accounts receivable. The hardware infrastructure comprises a database server 2, an application server 3, and a plurality of client computers 1. The database server 2 stores accounts receivable data of an enterprise. The application server 3 can electronically visit a sales management system 5 and a bank note management system 6 and retrieve data therefrom via a communications network 4. The sales management system 5 is used for managing and storing sales data of the enterprise, the sales data comprising sales records, sales revenue, accounts receivable and so on. The bank note management system 6 is used for managing and storing payment data of customers, the payment data comprising bank note types, issuing dates, maturity dates and so on. Each client computer 1 can visit the application server 3 via the communications network 4, and further access data stored in the database server 2 via the application server 3. The communications network 4 can be the Internet or an intranet.

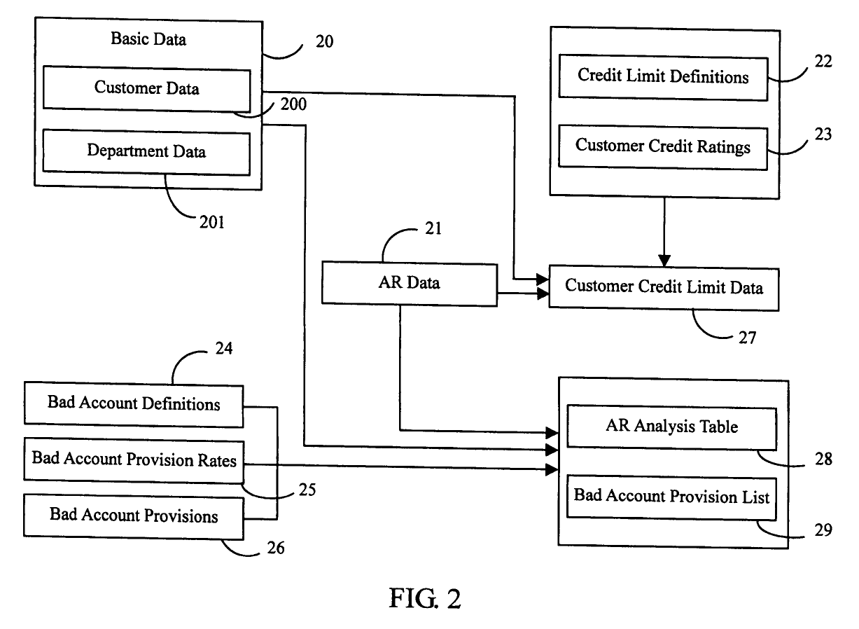

FIG. 2 is a block diagram showing data stored in the database server 2. Said data comprise basic data 20, accounts receivable (AR) data 21, credit limit definitions 22, customer credit ratings 23, bad account definitions 24, bad account provision rates 25, and bad account provisions 26.

The basic data 20 comprises customer data 200 and department data 201. The customer data 200 is for storing basic data on customers, including customers' names, addresses, contact details, client banks, transaction records and so on. The department data 201 stores basic data of internal departments of the enterprise, including main products, main customers, managers, internal accounts and so on.

The AR data 21 include all data related to accounts receivable, such as dates, sums, customers, payment terms, discount terms and so on. The AR data 21 are collected from the sales management system 5 and the bill note management system 6, and can be automatically updated accordingly. When a new transaction is added to the sales management system 5, a new AR record is automatically added to the AR data 21 according to the transaction. Similarly, when the bank note management system 6 confirms a payment record of a customer, the accounts receivable of the customer is correspondingly updated in the AR data 21.

The credit limit definitions 22 define accounts receivable limits of different customer credit ratings. Each credit rating corresponds to a pre-defined credit limit, and each customer is assigned a credit rating in advance. A customer with a higher credit rating has a higher credit limit.

The customer credit ratings 23 records credit ratings of current customers.

The bad account definitions 24 define types of bad accounts. The bad account provision rates 25 record provision rates of different bad account types. The bad account provisions 26 store current bad account provisions of the enterprise.

The database server 2 further comprises customer credit limit data 27, which store all valid credit limits of current customers. The customer credit limit data 27 is synchronously updated according to the AR data 21, the customer credit ratings 23 and the credit limit definitions 22. When the accounts receivable related to a customer is increased in the AR data 21 for the fulfillment of a purchase order released by the customer, the credit limit related to the customer is decreased by a corresponding sum. Similarly, when the accounts receivable related to the customer is decreased following a payment, the credit limit related to the customer is increased by a corresponding sum.

The database server 2 further comprises an AR analysis table 28, and a bad account provision list 29. The AR analysis table 28 shows dates, customers, sums and other data of accounts receivable. The bad account provision list 29 shows the statuses of all bad accounts.

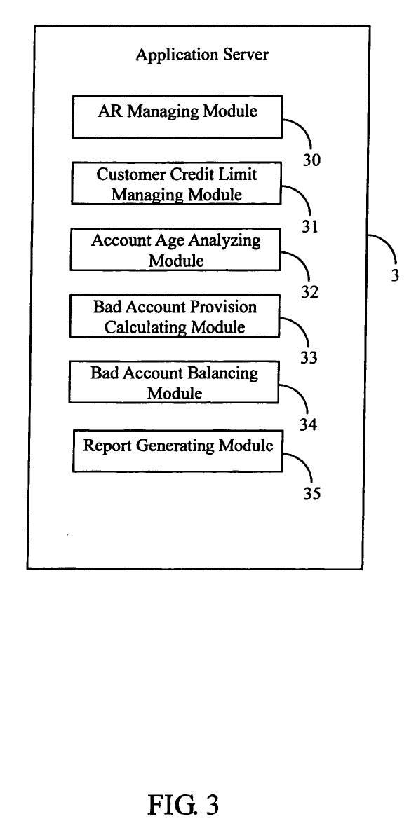

FIG. 3 is a schematic diagram of main function modules of the application server 3. The application server 3 comprises an accounts receivable (AR) managing module 30, a customer credit limit managing module 31, an account age analyzing module 32, a bad account provision calculating module 33, a bad account balancing module 34, and a report generating module 35.

The AR managing module 30 is for managing the AR data 21 stored in the database server 2, and automatically updating the AR data 21 according to input from the sales management system 5 and the bill note management system 6.

The customer credit limit managing module 31 is for managing customers' credit ratings and current credit limits. An authorized user can set or modify customers' credit ratings and credit limits.

The account age analyzing module 32 is provided for users to analyze ages of accounts receivable. By using the account age analyzing module 32, an authorized user can obtain all overdue accounts receivable data and corresponding bad account provision rates for respective accounts receivable.

The bad account provision calculating module 33 is for automatically calculating a bad account provision according to a bad account provision rate for each account receivable. The bad account balancing module 34 is for updating the bad account provisions 26 in the database server 2, and automatically generating corresponding accounting entries. The report generating module 35 is for generating relevant reports.

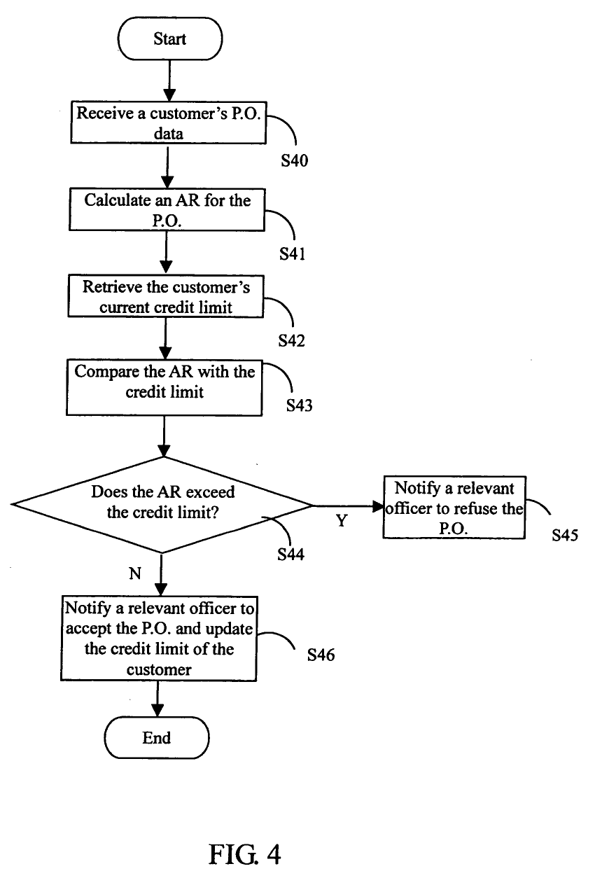

FIG. 4 is a flowchart for managing a customer's credit limit, in accordance with the present invention. In step S40, the application server 3 receives a customer's purchase order data from the sales management system 5 via the communications network 4. In step S41, the AR managing module 30 of the application server 3 calculates an account receivable for the purchase order according to the received data. More than one account receivable may need to be calculated for the purchase order. However, for the sake of simplicity, it will be assumed hereafter that only one account receivable is calculated. In step S42, the current credit limit of the customer is retrieved from the database server 2. In step S43, the application server 2 compares the account receivable of the purchase order with the credit limit. In step S44, the application server 2 determines whether the account receivable exceeds the credit limit. If the account receivable exceeds the credit limit, in step S45, the application server automatically notifies a relevant officer to refuse the purchase order. If the account receivable does not exceed the credit limit, in step S46, the application server 3 notifies a relevant officer to accept the purchase order, and updates the credit limit of the customer in the database server 2. That is, the sum of the account receivable is subtracted from the credit limit of the customer.

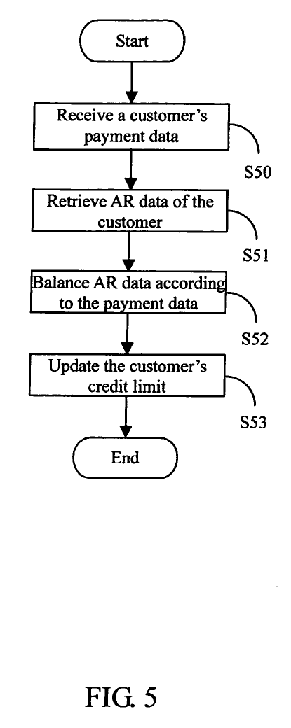

FIG. 5 is a flowchart for adjusting a customer's credit limit after a payment by the customer, in accordance with the present invention. In step S50, the application server 3 receives a customer's payment data from the bill note management system 6 via the communications network 4. In step S51, the application server 3 retrieves the accounts receivable data of the customer from the database server 2. In step S52, the accounts receivable data is balanced in accordance with the sum of the customer's payment. In step S53, the application server 3 updates the credit limit of the customer in the database server 2. That is, the sum of the payment is added to the credit limit of the customer.

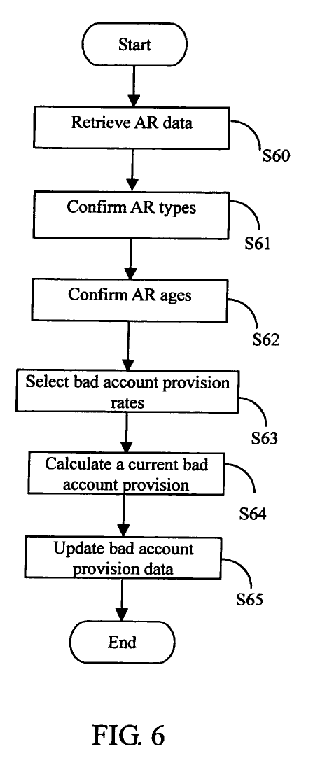

FIG. 6 is flowchart for calculating a bad account provision, in accordance with the present invention. In step S60, the application server 3 retrieves accounts receivable data from the database server 2. In step S61, the application server 3 confirms the types of accounts receivable. Different types of accounts receivable have different bad account provision rates. In step S62, the application server 3 confirms the ages of the accounts receivable. In step S63, the application server 3 automatically selects bad account provision rates for the accounts receivable. That is, an account receivable with a longer overdue time has a higher bad account provision rate. In step S64, the application server 3 calculates a current bad account provision for accounts receivable according to the AR types, the AR ages, and the bad account provision rates. In step S65, the application server 3 updates the bad account provision data stored in the database server 2.

The preferred embodiments described herein are merely illustrative of the principles of the present invention. Other arrangements and advantages may be devised by those skilled in the art without departing from the spirit and scope of the present invention. Accordingly, the present invention should be deemed not to be limited to the above detailed description, but rather by the spirit and scope of the claims which follow and their equivalents.

What is claimed is:

1. A method for managing credit limits of accounts receivable, the method comprising the steps of:
receiving purchase order data of a customer;
calculating an account receivable of the purchase order according to the received purchase order data;
retrieving credit limit data of the customer from a database server;
comparing the account receivable of the purchase order with a credit limit;
notifying a relevant officer to refuse the purchase order when the account receivable of the purchase order exceeds the credit limit; and
notifying a relevant officer to accept the purchase order when the account receivable of the purchase order does not exceed the credit limit, and subtracting the sum of the account receivable of the purchase order from the credit limit in the database server.

2. The method as claimed in claim 1, further comprising the steps of:
receiving payment data of the customer; and
adding a sum of a payment of the customer to the credit limit in the database server.

3. The method as claimed in claim 2, wherein the step of adding the sum of the payment to the credit limit in the database server comprises the steps of:
retrieving accounts receivable data on the customer from the database server;
balancing accounts receivable of the customer according to the payment data; and
increasing the credit limit according to the balanced accounts receivable.

4. The method as claimed in claim 1, further comprising the step of:
setting a plurality of credit ratings, each of the credit ratings corresponding to a particular credit limit.

5. The method as claimed in claim 4, further comprising the step of:
selecting a credit rating for the customer.

6. A method for managing credit limits of accounts receivable, the method comprising the steps of:
setting a plurality of credit ratings, each of the credit ratings corresponding to a particular credit limit;
selecting a credit rating for each of customers, corresponding credit rating data being stored in a database server;
receiving purchase order data of a particular customer;
calculating an account receivable of the purchase order according to the received purchase order data;
retrieving credit limit data of the customer from the database server;
comparing the account receivable of the purchase order with a credit limit of the customer;
notifying a relevant officer to refuse the purchase order when the account receivable of the purchase order exceeds the credit limit;
notifying a relevant officer to accept the purchase order when the account receivable of the purchase order does not exceed the credit limit, and subtracting the sum of the account receivable of the purchase order from the credit limit in the database server;
receiving payment data of the customer; and
adding a sum of a payment of the customer to the credit limit in the database server.

7. The method as claimed in claim 6, wherein the step of adding the sum of the payment to the credit limit in the database server comprises the steps of:
retrieving accounts receivable data on the customer from the database server;
balancing accounts receivable of the customer according to the payment data; and
increasing the credit limit according to the balanced accounts receivable.

8. A process of updating a bad account provision, comprising steps of:
retrieving accounts receivable data;
confirming types of accounts receivable wherein said types have different bad account provision rates;
confirming ages of the accounts receivable wherein the account receivable having longer overdue time has a higher bad account provision rate;
automatically selecting different account provision rates for said accounts receivable based upon both said types and said ages; and
calculating a current bad account provision based upon the accounts receivable and the corresponding bad account provision rates.
